(19) United States
(12) Patent Application Publication
(10) Pub. No.: US 2010/0214184 A1
(43) Pub. Date: Aug. 26, 2010

(54) ANTENNA DEVICES AND SYSTEMS FOR MULTI-BAND COVERAGE IN A COMPACT VOLUME

(75) Inventors: Allen M. Tran, San Diego, CA (US); Sreenivas Kasturi, San Diego, CA (US); Steven J. Lundgren, Ramona, CA (US); Julio Zegarra, La Jolla, CA (US); Arthur Page, JR., Encinitas, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/392,028

(22) Filed: Feb. 24, 2009

(51) Int. Cl. H01Q 21/30; H01Q 1/36; H01Q 9/30; H01Q 1/38

(52) U.S. Cl. 343/725; 343/895; 343/900; 343/700 MS

(57) ABSTRACT

A multi-band antenna device includes a primary antenna with a helical component and a folded component. A wire is formed in a helix to construct the helical component and a wire is formed in a folded-over fashion to form the folded component. The folded component is disposed inside the helix. The helical component and folded component may be formed with separate wires or as one continuous wire. The primary antenna is for resonating in multiple frequency bands including a first frequency band correlated with the helical component and a second frequency band correlated with the folded component. A secondary antenna may be included to provide diversity and possibly other frequency bands. The secondary antenna includes a planar inverted F antenna.

### BACKGROUND

As communication options for computers and cellular telephones grow, so do the frequencies used in these communication devices. In addition, communication products are constantly getting smaller. This combination of small form factors and need for multi-band coverage makes antenna design very problematic.

In the past, covering some of these frequency ranges has been performed with devices that include a deployable antenna to get a larger antenna size. However, deployable antennas may cause problems. The user may forget to deploy the antenna, degrading performance, and the antenna is susceptible to breakage.

There is a need for antennas and antenna systems for covering a broad range of communication frequencies in a small volume.

### BRIEF DESCRIPTION OF THE DRAWINGS

FIG. 1 shows an embodiment of a primary antenna including a helical component and a folded component.

FIG. 2A shows another embodiment of a primary antenna as a single wire.

FIG. 2B shows the primary antenna of FIG. 2A with a stabilizer disposed within a portion of the helical component and surrounding a portion of the folded component.

FIG. 3 shows a primary antenna attached to a circuit board.

FIG. 4 shows a perspective view of a circuit board bearing a primary antenna and a secondary antenna.

FIG. 5 is a simplified block diagram of an antenna system including a primary antenna and a secondary antenna.

FIG. 6 is a graph of return loss for a primary antenna over a broad frequency range.

FIG. 7 is a graph of return loss for a secondary antenna over a broad frequency range.

FIG. 8 shows a computer peripheral for providing wireless communication capabilities to a computer when coupled thereto.

FIG. 9 shows a partially disassembled view of the computer peripheral of FIG. 8.

FIG. 10 shows a back-side of a communication device housing for holding the primary antenna and the secondary antenna.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Exemplary embodiments of the present invention are directed to antennas and antenna systems for covering a broad range of communication frequencies in a small volume. As stated earlier, an internal antenna that does not need to be deployed may be more desirable than a deployable antenna.

Exemplary embodiments of the present invention provide coverage of a large range of frequency bands in a very limited volume. Some exemplary frequency bands that may be covered are Global Positioning Satellite (GPS) frequencies, Universal Mobile Telecommunications System (UMTS) 850, UMTS 900, UMTS 1700, UMTS 1900, UMTS 2100, and combinations thereof. The GPS frequencies are generally a bandwidth of about 2 MHz centered around about 1.575 GHz. UMTS 850 may also be referred to as a United States cellular band and generally covers frequencies of about 824 to 894 GHz. UMTS 900 may also be referred to as European cellular band and generally covers frequencies of about 880 to 960 GHz. UMTS 1700 may also be referred to as European Digital Cellular System (DCS) band and generally covers frequencies of about 1710 to 1880 GHz. UMTS 1900 may also be referred to as a United States Personal Communication System (PCS) band and generally covers frequencies of about 1850 to 1990 GHz. UMTS 2100 may also be referred to as an International Mobile Telecommunications (IMT 2100) band and generally covers frequencies of about 1930 to 2170 GHz.

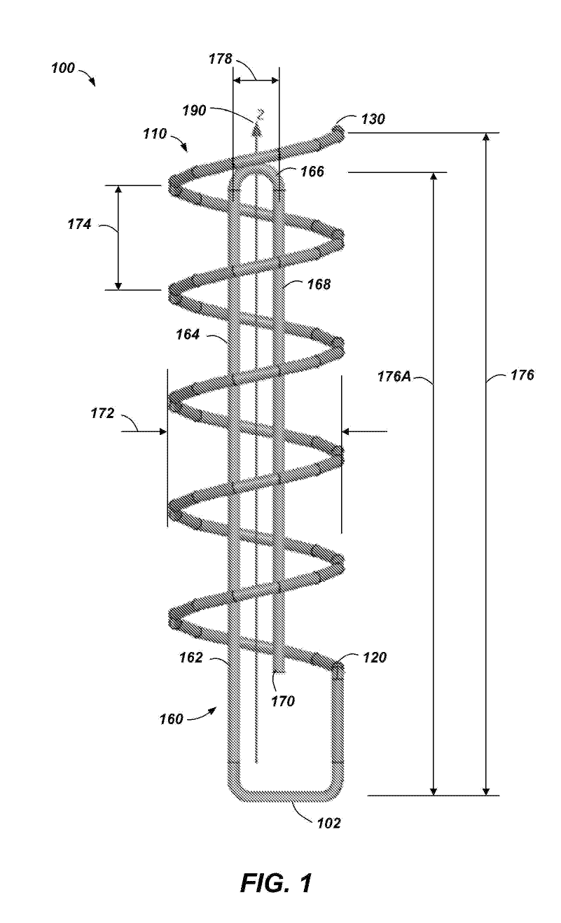

FIG. 1 shows an embodiment of a primary antenna 100 including a helical component 110 and a folded component 160. The helical component 110 (may also be referred to herein as a helical segment and a helical wire component) extends from a first helix end 120 to a second helix end 130. The first helix end 120 may also be referred to herein as a helical-attachment end 120. The second helix end 130 may also be referred to herein as a distal end 130.

The folded component 160 (may also be referred to herein as a folded segment and a folded wire component) is disposed inside the helix and is comprised of a wire that is folded back on itself. In other words, the folded component 160 extends from a folded-attachment end 162 through a first linear segment 164 to a U-turn end 166 through a second linear segment 166 to a folded end 170 that is back near the folded-attachment end 162 and the first helix end 120.

The helical component 110 and the folded component 160 may be formed as two separate electrically conductive wires or formed from a single electrically conductive wire 102 as is shown in FIG. 1. In the exemplary embodiment shown in FIG. 1 the wire has a radius of about 0.4 mm, the helix includes about 5.4 turns with a diameter 172 of about 6 mm, a turn-to-turn spacing 174 of about 3.6 mm, and an uncompressed height 176 of about 23 mm. In some embodiments, the helical component 110 may be compressed when placed in a housing to a compressed height 176A of about 20 mm.

The folded component 160 extends in an axial direction 190 from the folded-attachment end 162 to near the distal end 130 of the helix then takes a U-turn to extend back to near the first helix end 120. In the exemplary embodiment shown in FIG. 1, the U-turn creates a center-to-center spacing 178 of about 1.5 mm between the first linear segment 164 and the second linear segment 168.

By using two components (i.e., the helical component 110 and the folded component 160), the primary antenna 100 according to various embodiments provides multiple frequency bands and broad frequency ranges in a very compact volume. The frequency ranges will be described more fully below. The overall volume may be described as π*R²*H; where R=the radius of the helix and H=the height of the helix. Thus, as non-limiting examples, the volume of the primary antenna in FIG. 1 is about π*3²*23=650 mm³ in an uncompressed state and about π*3²*20=565 mm³ in a compressed state.

Of course, those of ordinary skill in the art will recognize that within the scope of the present invention the physical dimensions of the primary antenna 100 may be modified and tuned to accomplish various resonant frequencies and fit into different volumetric form factors. The dimensions given for the embodiment of FIG. 1 are meant for discussion and example only and not to limit the scope of the present invention.

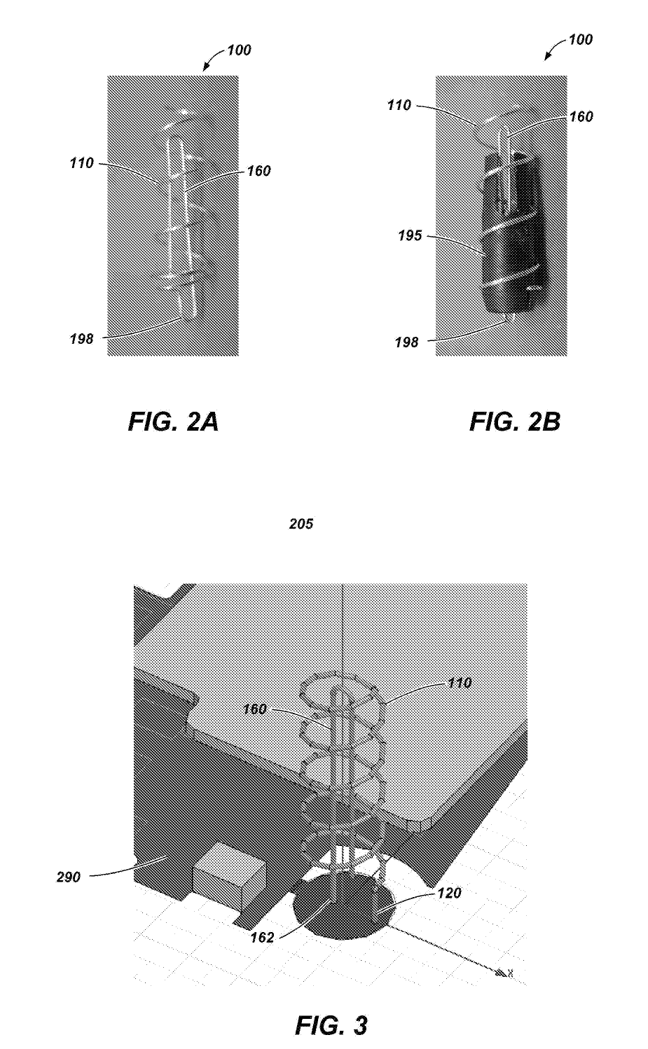

FIG. 2A shows another embodiment of a primary antenna 100 as a single wire. In the embodiment of FIG. 2A, the helical component 110 and the folded component 160 are joined at a single attachment point 198.

FIG. 2B shows the primary antenna 100 of FIG. 2A with a stabilizer 195 disposed within a portion of the helical component 110 and surrounding a portion of the folded component 160. The attachment point 198 is exposed for a press fit connection to a circuit board 290 as is explained below. The stabilizer 195 adds structural stability to the primary antenna 100 and assists in assembly.

FIG. 3 shows the primary antenna 100 attached to a circuit board 290. In the exemplary embodiment of FIG. 3, the helical segment 110 is formed from a first wire and the folded segment 160 is formed from a second wire. Thus, the helical segment 110 is attached to the circuit board 290 at the helical-attachment end 120 and the folded segment 160 is attached to the circuit board 290 at the folded-attachment end 162.

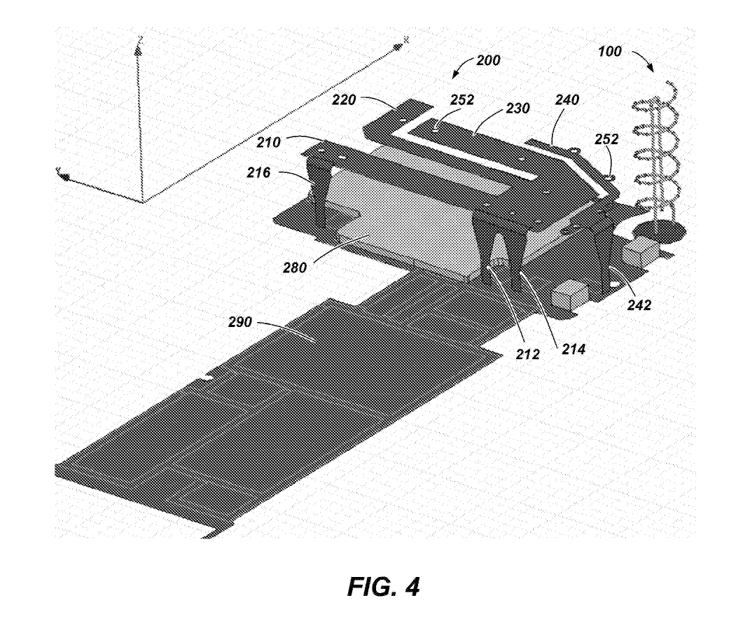

FIG. 4 shows a perspective view of a circuit board 290 bearing a primary antenna 100 and a secondary antenna 200. The secondary antenna 200 is configured as a planar inverted F antenna 200, which includes three connected arms (210, 220, and 230) and a separate passively coupled arm 240. A shield 280 formed of a suitable conductive material may be included to shield the planar inverted F antenna 200 from other components on the circuit board 290.

The planar inverted F antenna 200 is connected to the circuit board 290 at three connection points. A first leg 212 is coupled to ground on the circuit board 290. A second leg 214 is coupled to a feed point 214 on the circuit board 290 for connecting to provide an excitement point for the secondary antenna 200. A third leg 216 is coupled to ground on the circuit board 290 through a tuning capacitor (not shown in FIG. 4). A fourth leg 242 couples the passively coupled arm 240 to ground on the circuit board 290.

The planar inverted F antenna 200 may be connected with the primary antenna 100 in an antenna system to provide diversity for the primary antenna 100, cover additional frequency bands, or a combination thereof. As non-limiting examples, the planar inverted F antenna 200 may provide spatial and pattern diversity for the primary antenna 100.

The passively coupled arm 240 is electromagnetically coupled to the planar inverted F antenna 200 to provide resonance at higher frequency bands, such as, for example, UMTS 1900 and UMTS 2100. The second arm 220 provides resonance at the GPS frequency band. The first arm 210 provides resonance at lower frequency bands, such, as, for example, UMTS 850 and UMTS 900.

The planar inverted F antenna 200 shown in FIG. 4 has a width in the x-direction of about 21 mm, a length in the y-direction of about 42 mm, and a height above the circuit board 290 in the z-direction of about 10 mm. The planar inverted F antenna 200 includes holes 252 to assist in attachment to a communication device housing and provide support, as will be explained below.

Of course, those of ordinary skill in the art will recognize that within the scope of the present invention the physical dimensions of the secondary antenna 200 and arm configurations may be modified and tuned to accomplish various resonant frequencies and fit into different volumetric form factors. The dimensions and arm configurations given for the embodiment of FIG. 4 are meant for discussion and example only and not to limit the scope of the present invention

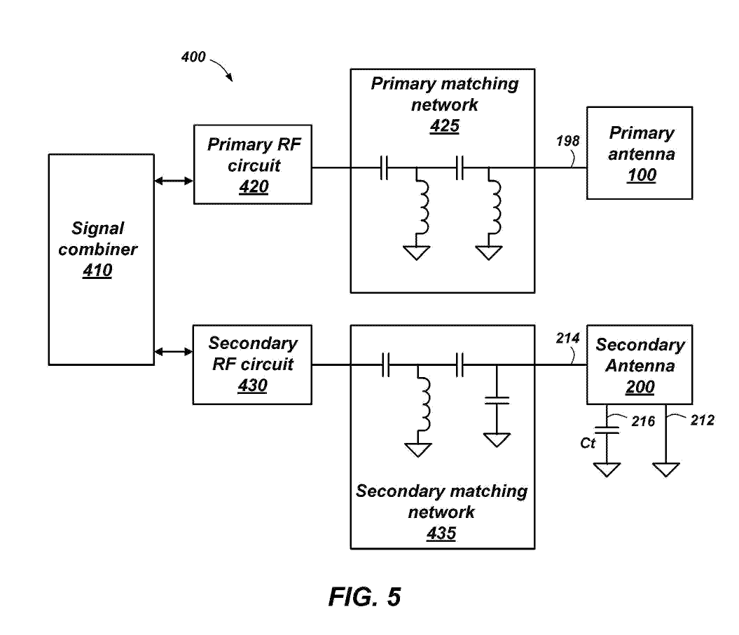

FIG. 5 is a simplified block diagram of an antenna system 400 including a primary antenna 100 and a secondary antenna 200. The primary antenna 100 couples to a primary matching network 425 through the attachment point 198. The primary matching network 425 also couples to a primary radio frequency (RF) circuit 420.

The secondary antenna 200 couples to a secondary matching network 435 through the feed point 214. The secondary matching network 435 also couples to a secondary RF circuit 430. The secondary antenna 200 also includes a tuning capacitor (Ct) attached to the third leg 216 (see FIG. 4) and the second leg 214 (see FIG. 4) attached to ground. The tuning capacitor provides a tuning capacity for adjusting resonance of the secondary antenna 200 at the lower frequencies.

The Matching networks (425 and 435) are configured to match the impedance between their corresponding antenna (100 and 200) and RF circuit (420 and 430). The RF circuits (420 and 430) provide signal conditioning operations such as, for example, amplification and filtering.

A signal combiner 410 couples to the primary RF circuit 420 and the secondary RF circuit 430. The signal combiner 410 may be used to combine the signals from the primary antenna 100 and the secondary antenna 200 in a manner to create diversity between the two antennas, enhance band coverage, introduce new band coverage, and combinations thereof. As non-limiting examples, the signal combiner 410 may perform functions such as beam steering, null steering, enhancing aperture gain, and enhancing array gain. In addition, the signal combiner 410 may be configured to lower interference between the two antennas. All of these functions may be used to increase overall signal to noise ratio in the desired bands as a whole or in specific bands that may be in current use by the antenna system 400. The signal combiner attaches to other communication processing circuitry (not shown) to complete a communication link.

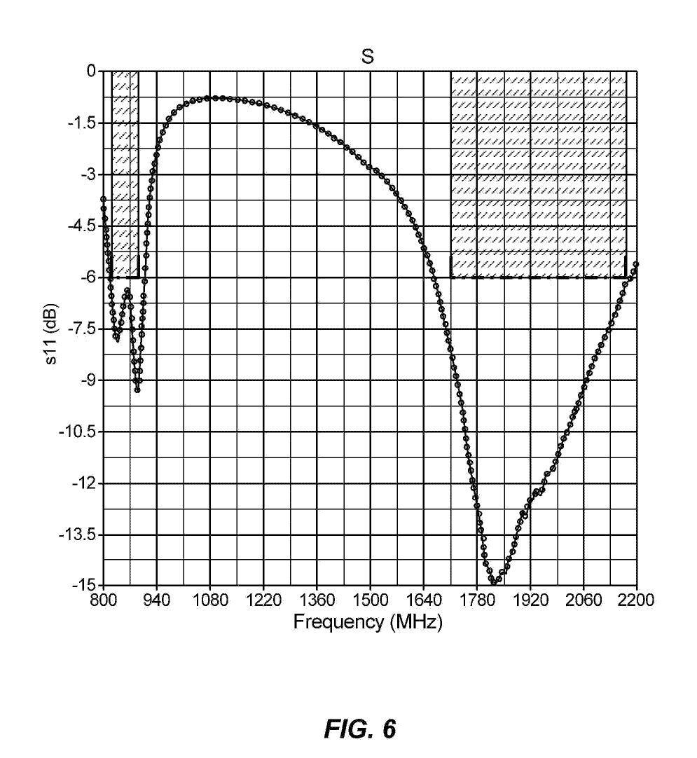

FIG. 6 is a graph of return loss for a primary antenna 100 (FIG. 1) over a broad frequency range. Curve 302 shows return loss for the primary antenna over a frequency range of 800 to 2200 GHz. A low return loss (i.e., a larger negative number) indicates a good resonance capability at that frequency. A first frequency band 380 is shown where acceptable return loss is achieved at the lower frequencies, such as, for example, UMTS 850 and UMTS 900. A second frequency band 390 is shown where acceptable return loss is achieved at the higher frequencies, such as, for example, UMTS 1700, UMTS 1900, and UMTS 2100. In the primary antenna 100 embodiment of FIG. 1, the helical component 110 may resonate acceptably at UMTS 850, UMTS 900, and UMTS 1700 and the folded component 160 may resonate acceptably at UMTS 1900 and UMTS 2100.

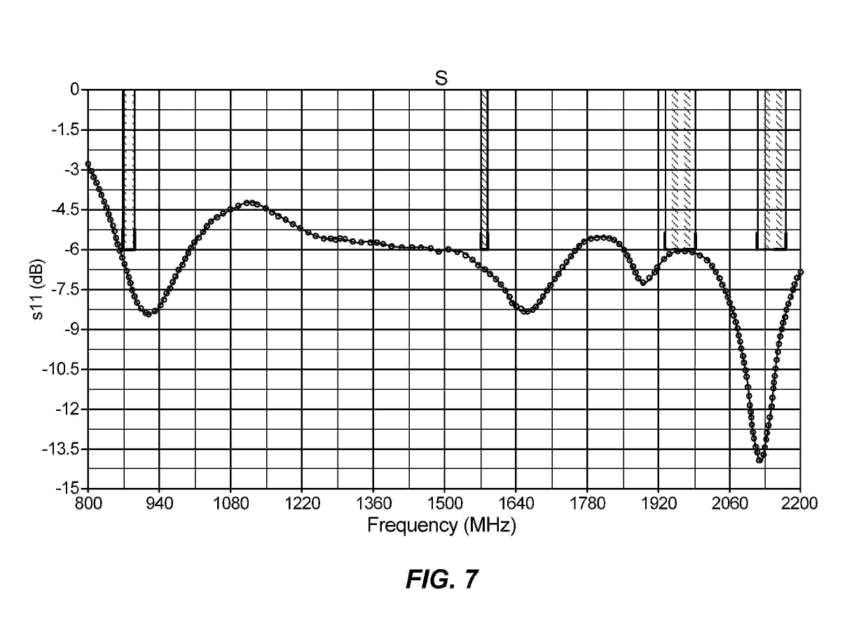

FIG. 7 is a graph of return loss for a secondary antenna 200 (FIG. 4) over a broad frequency range. Curve 304 shows return loss for the secondary antenna 200 over a frequency range of 800 to 2200 GHz. The UMTS 850 band 310 is shown as providing low return loss. In addition, while not shown, it can be seen that good return loss is available at the UMTS 900 frequency band. The GPS band 360 is shown as providing low return loss. At the higher frequencies, the UMTS 1900 band 340 and UMTS 2100 band 350 are shown as providing low return loss.

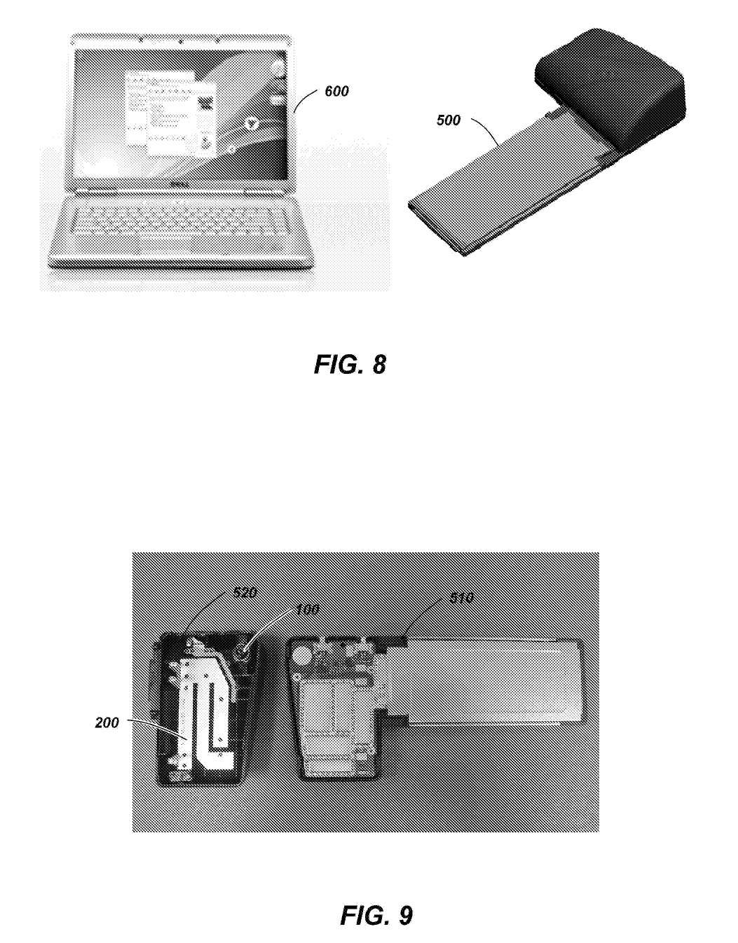

FIG. 8 shows a computer peripheral 500 for providing wireless communication capabilities to a computer 600 when coupled thereto. Clearly, the computer peripheral 500 is shown at a much larger scale than the computer 600. The computer peripheral 500 is shown as an express card type modem with dimensions of about 54 mm×32 mm×12 mm. The section on the right end, where the antennas are housed, may have a height of about 20 mm. Of course, those of ordinary skill in the art will recognize that embodiments of the present invention may be used in a number of different form factors and communication devices that only have a small volume available for antenna systems. As non-limiting examples, some of these devices may be Universal Serial Bus dongles, other parallel and serial bus cards, and cellular telephones.

FIG. 9 shows a partially disassembled view of the computer peripheral 500 of FIG. 8. A lower portion 510 contains a circuit board and other components. An upper portion 520 (also referred to herein as a communication device housing) holds the planar inverted F antenna 200 and the primary antenna 100. The helical portion of the primary antenna 100 may be partially compressed when the upper portion 520 is assembled with the lower portion 510. This partial compression reduces the volume consumed by the primary antenna 100 and provides reliable contact with the circuit board when assembled.

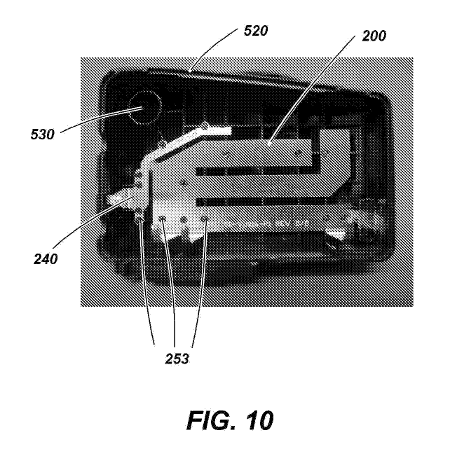

FIG. 10 shows another view of the communication device housing for holding the primary antenna (not shown) and the secondary antenna 200. A cavity 530 is shown for accepting the primary antenna. The planar inverted F antenna 200 and the passively coupled arm 240 may be formed from stamped metal bent into shape to generate the various legs (see FIG. 4). To secure them in place, and provide structural support, plastic stakes 253 may be inserted through the holes (FIG. 4) in the planar inverted F antenna 200 and the passively coupled arm 240. A simple compression fit contacts the legs (FIG. 4) with the circuit board when the communication device housing 520 is assembled with the lower half 510 (FIG. 9).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An electrically conductive wire, comprising:
a helical segment for resonating in a first frequency band and comprising a helix formed by the electrically conductive wire between a first helix end and a second helix end;
a folded segment disposed inside the helix for resonating in a second frequency band and comprising a first linear segment extending from substantially near the first helix end to a folded end and a second linear segment extending from the folded end to substantially near the first helix end.

2. The electrically conductive wire of claim 1, wherein the electrically conductive wire occupies a volume of less than about 750 cubic millimeters.

3. The electrically conductive wire of claim 1, wherein the helical segment is partially compressed in an axial direction between the first helix end and the second helix end when the electrically conductive wire is disposed in a communication device housing.

4. The electrically conductive wire of claim 3, wherein the electrically conductive wire occupies a volume of less than about 650 cubic millimeters when the helical segment is partially compressed.

5. The electrically conductive wire of claim 1, wherein the first frequency band and the second frequency band are selected to span at least two of the bands consisting of a global positioning satellite frequency band, Universal Mobile Telecommunications System (UMTS) 850, UMTS 900, UMTS 1700, UMTS 1900, UMTS 2100, and combinations thereof.

6. A multi-band antenna device, comprising:
a helical component comprising a first wire formed in a helix with a helical-attachment end and a distal end at the opposite end of the helix from the helical-attachment end;
a folded component disposed inside the helix, comprising:
a second wire formed in a folded arrangement including a folded-attachment end operably coupled to the helical-attachment end and disposed near the helical-attachment end, a U-turn end disposed near the distal end, and a folded end disposed near the folded-attachment end;
wherein the multi-band antenna device is for resonating in a plurality of frequency bands comprising a first frequency band correlated with the helical component and a second frequency band correlated with the folded component.

7. The multi-band antenna device of claim 6, wherein the first wire and the second wire comprise a single wire such that the helical-attachment end and the folded-attachment end are at the same location on the single wire.

8. The multi-band antenna device of claim 6, wherein the helical component and the folded component occupy a volume of less than about 750 cubic millimeters.

9. The multi-band antenna device of claim 6, wherein the helical component is partially compressed in an axial direction between the helical-attachment end and the distal end when the helical component is disposed in a communication device housing.

10. The multi-band antenna device of claim 9, wherein the helical component and the folded component occupy a volume of less than about 650 cubic millimeters when the helical component is partially compressed.

11. The multi-band antenna device of claim 6, wherein the plurality of frequency bands are selected from the bands consisting of a global positioning satellite frequency band, Universal Mobile Telecommunications System (UMTS) 850, UMTS 900, UMTS 1700, UMTS 1900, UMTS 2100, and combinations thereof.

12. The multi-band antenna device of claim 6, further comprising a secondary antenna configured as a planar inverted F antenna for resonating near two or more of the plurality of frequency bands.

13. The multi-band antenna device of claim 12, wherein the one or more of the plurality of frequency bands are selected from the bands consisting of a global positioning satellite frequency band, Universal Mobile Telecommunications System (UMTS) 850, UMTS 900, UMTS 1700, UMTS 1900, UMTS 2100, and combinations thereof.

14. The multi-band antenna device of claim 12, wherein the planar inverted F antenna includes a plurality of arms for resonating substantially near the two or more of the plurality of frequency bands.

15. The multi-band antenna device of claim 12, wherein the planar inverted F antenna includes a passively coupled arm disposed planar with and substantially near the planar inverted F antenna for resonating substantially near one or more of the plurality of frequency bands.

16. An antenna system, comprising:
a primary antenna for resonating at a plurality of frequency bands to form a first resonant signal, the primary antenna comprising a helical wire component and a folded wire component disposed inside the helical wire component;
a secondary antenna for providing diversity by resonating near at least one of the plurality of frequency bands to form a second resonant signal, the secondary antenna comprising a planar inverted F antenna; and
a signal combiner operably coupled to the primary antenna and the secondary antenna, the signal combiner for selectively merging the first resonant signal and the second resonant signal.

17. The antenna system of claim 16, wherein the helical wire component and the folded wire component comprise a single wire.

18. The antenna system of claim 16, wherein the antenna system is for disposition in a volume of less than about 750 cubic millimeters.

19. The antenna system of claim 16, wherein the antenna system is for disposition in a computer peripheral for providing wireless communication capabilities for a computer.

20. The antenna system of claim 19, wherein the helical wire component is partially compressed when disposed in the computer peripheral to occupy a volume of less than about 650 cubic centimeters.

21. The antenna system of claim 16, wherein the plurality of frequency bands are selected from the bands consisting of a global positioning satellite frequency band, Universal Mobile Telecommunications System (UMTS) 850, UMTS 900, UMTS 1700, UMTS 1900, UMTS 2100, and combinations thereof.

22. The antenna system of claim 16, wherein the planar inverted F antenna includes a plurality of arms for resonating substantially near two or more of the plurality of frequency bands.

23. The antenna system of claim 16, wherein the planar inverted F antenna includes a passively coupled arm disposed planar with and substantially near the planar inverted F antenna for resonating substantially near one or more of the plurality of frequency bands.

24. An antenna system, comprising:
a means for providing a first resonant signal over a plurality of frequency bands, the means comprising a helical wire component and a folded wire component disposed inside the helical wire component;
a means for providing a second resonant signal over at least one of the plurality of frequency bands, the means comprising a planar inverted F antenna; and
a means for combining the first resonant signal and the second resonant signal.

25. The antenna system of claim 24, further comprising a means for partially compressing the helical wire component in an axial direction.

26. The antenna system of claim 24, further comprising a means for securing in place the means for providing the first resonant signal and means for providing the second resonant signal.

27. The antenna system of claim 24, wherein one or more of the plurality of frequency bands are selected from the bands consisting of a global positioning satellite frequency band, Universal Mobile Telecommunications System (UMTS) 850, UMTS 900, UMTS 1700, UMTS 1900, UMTS 2100, and combinations thereof.

28. The antenna system of claim 24, wherein the planar inverted F antenna includes a means for resonating substantially near two or more of the plurality of frequency bands.
